(19) United States
(12) Patent Application Publication
(10) Pub. No.: US 2012/0135751 A1
(43) Pub. Date: May 31, 2012

(54) USE OF LOCATION TAGGING IN DATA COMMUNICATIONS

(75) Inventor: Arunesh Mishra, Sunnyvale, CA (US)

(73) Assignee: GOOGLE INC., Mountain View, CA (US)

(21) Appl. No.: 13/308,087

(22) Filed: Nov. 30, 2011

Related U.S. Application Data
(60) Provisional application No. 61/418,219, filed on Nov. 30, 2010.

(51) Int. Cl. H04W 24/00

(52) U.S. Cl. 455/456.1

(57) ABSTRACT

Methods, systems, and apparatus, including computer programs for receiving communication data, determining a current geographic location of a computing device in response to receipt of the communication data, defining location data corresponding to the current geographic location, receiving user input at the computing device, the user input being indicative of a reaction of a user to receipt of the communication data, defining user reaction data based at least in part on the user input, defining one or more rules for reacting to received communication data based at least in part on the user reaction data and the location data, receiving subsequent communication data, and responding to the subsequent communication data based at least in part on the one or more rules.

### CROSS-REFERENCE TO RELATED APPLICATIONS

This application claims the benefit of U.S. Prov. Pat. App. No. 61/418,219, filed Nov. 30, 2010, the disclosure of which is expressly incorporated herein by reference in its entirety.

### BACKGROUND

A mobile communication device can be used to communicate via a mobile communication network. A mobile communication network can be a cellular network of base stations and/or cell sites. One example of a mobile communication device is a mobile phone or cell phone. A mobile phone can connect to a cellular network owned, for example, by a mobile network service provider. The mobile phone can switch this connection from one base station, cell site, or cellular network to another as it travels through coverage areas, and thereby provide an uninterrupted connection. For example, a user can place a phone call to and/or receive a phone call from another mobile phone or landline phone and receive uninterrupted service while traveling. A so-called smartphone can be a mobile phone that includes standard voice functions (call sending and receiving) along with additional functions and applications such as Short Message Service (SMS) text messaging, voice mail services, electronic mail (email) capabilities, mobile applications, packet switching for Internet access, an onboard digital camera, and/or Global Positioning System (GPS) capabilities. In some implementations, a smartphone user may access a web site for their particular service provider to select and download applications for use on their smartphone.

### SUMMARY

A user of a mobile communication device (e.g., a mobile phone) can send and receive communication data (e.g., phone calls, SMS text messages, email, alerts, etc.) anywhere the mobile communication device can access a mobile communication network. For example, a user may wish to send and/or receive communication data while physically located at a user's home, office, or at a store, theater, medical office, hospital, stadium, and/or theater. There may be certain circumstances where the user is located in a particular location where he/she may not want to acknowledge incoming communication data. For example, the user may choose to not answer incoming phone calls while in a theater. In another example, the user may choose to not acknowledge any incoming communication data from friends and family while in their office. In addition, while in the office attending a meeting in a conference room, the user may only acknowledge incoming communication data from important superiors (e.g., the company CEO). In another example, the user may choose to not acknowledge any incoming communication data from work-related contacts while at home. As such, the user may choose to acknowledge and/or respond to incoming communication data received at a mobile communication device (e.g., phone calls, text messages, email messages, and/or alerts on their mobile phone) based at least in part on their current location.

According to innovative aspects of the subject matter described in this specification, the response/reaction of a user to incoming communication data received at a mobile communication device while physically located at a particular geographic location in the past can be used by the mobile communication device to predict/infer the user's likely response to subsequent incoming communication data received at the same (or a similar location) in the future. In addition, it may be desirable for the user to dynamically forward or selectively receive incoming communication data based on a current location description associated with the user's current geographic location. For example, a user may input information into the mobile communication such that the mobile communication network and/or mobile communication device dynamically forwards to voicemail all incoming phone calls received while the mobile communication device is located in a movie theater. In this example, the movie theater can be associated with the location label “movie theater.” The user's desired response to incoming communication data in either of these locations can be associated with the location label “movie theater.” In addition, the user's desired response and selected course of action for the incoming phone call (e.g., “go directly to voicemail”) can be associated with the location label. This dynamic forwarding of incoming phone calls can occur without the mobile phone ringing. Therefore, in such instances the user need not remember to enable silent/vibrate mode and/or turn off the mobile communication device while in the movie theater, as the phone will not ring.

In general, innovative aspects of the subject matter described in this specification may be embodied in methods that include the actions of receiving, at a computing device, communication data, defining, in response to receipt of the communication data, location data, the location data being based at least in part on a current geographic location of the computing device, receiving user input at the computing device, the user input being indicative of a reaction of a user to receipt of the communication data, defining one or more rules for reacting to received communication data, the one or more rules being defined based at least in part on the user input and the location data, receiving, at the computing device, subsequent communication data, and performing, in response to receipt of the subsequent communication data, an action, the action being performed at the computing device and being selected based at least in part on the one or more rules.

These and other embodiments may each optionally include one or more of the following features. For instance, actions further include transmitting the location data and the communication data to a server, the server defining the one or more rules and transmitting the one or more rules to the computing device; actions further include: displaying the one or more rules to the user in an interface on a display device included in the computing device, and receiving user validation of the one or more rules by way of the interface, where the user validation is received prior to receiving subsequent communication data; actions further include: receiving one or more modifications from the user by way of the interface, modifying the one or more rules based on the received user modifications to provide one or more modified rules, and storing the one or more modified rules on the computing device; the computing device is a mobile communication device; the communication data is one of a telephone call, a Short Message Service (SMS) message, an electronic mail (email) message, an instant message or an alert; determining a geographic location of the computing device further includes utilizing one of a Global Positioning System (GPS) or a location application program interface on the computing device; the one or more rules for reacting to received communication data are defined further based on an identity of the sender of the communication data, and a time of day associated with the receipt of the communication data; actions further include receiving user input for use as a reaction for the one or more rules; and the user input is one of a recorded voicemail response or automatic email response.

In general, innovative aspects of the subject matter described in this specification may be embodied in methods that include the actions of receiving, at a computing device, location data and reaction data corresponding to a reaction of a user of a mobile communication device to communication data received at the mobile communication device, processing the location data and the reaction data to define one or more rules for reacting to received communication data, and transmitting the one or more rules to one or more mobile communication devices.

These and other embodiments may each optionally include one or more of the following features. For instance, receiving the location data and the reaction data further includes storing the location data and the reaction data in a location mapping database on a server; and receiving the location data and the reaction data occurs at a set time of day.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 illustrates an example system that can execute implementations of the present disclosure.

FIG. 2 illustrates an example of location based tagging of incoming communication data.

FIG. 3 is a block diagram of a mobile communication device used for location based tagging of incoming communications data.

FIG. 4 illustrates server side logic used by a server for location based tagging of communication data.

FIG. 5 is a flowchart of an example process for location based tagging of incoming communication data.

FIG. 6 is a flowchart of an example process for generating a probabilistic model for use in location based tagging of incoming communication data.

Like reference numbers represent corresponding parts throughout.

### DETAILED DESCRIPTION

Implementations of the present disclosure are generally directed to location-based tagging of communication data. For example, a mobile communication device (e.g., a mobile phone) can receive incoming communication data (e.g., a phone call, a SMS text message) while in a location (e.g., home, school, office, theater, hospital, etc.). In some situations, the user may not want to receive and/or acknowledge the incoming communication data, based on where they are located. For example, a user will not answer calls received on their mobile phone while located in a movie theater.

In some implementations, an application running on a mobile communication device (e.g., mobile phone) can collect data regarding a user's behavior when receiving incoming communication data. In some implementations, the data is collected only after the user has provided explicit approval for the collection of such data. In some implementations, the user can opt into or opt out of such data collection. The data collected can include the type of communication data (e.g., telephone call, email, text message), and the response/reaction of the user (reaction data) to the incoming communication data and the geographic location of the user when receiving the incoming communication data. In addition, the data collected can include the identity of a source of the incoming communication data and the time of the receipt of the incoming communication data.

In some implementations, a location application running on the user's mobile communication device can provide location based information for the mobile communication device. For example, a Global Positioning System (GPS) built into the mobile communication device can determine the geographic location of the mobile communication device. In some implementations, a location application program interface running on the mobile communication device can determine the geographic location of the mobile communication device by computing the location of the device based on WiFi signals or cell-ids. An additional application or other type of software running on the mobile communication device can collect the location data for the mobile communication device and the reaction of the user (reaction data) when receiving the incoming communication data. In addition, the additional application or other type of software can determine the identity of the sender of the communication data and the time of day of receipt of the communication data, as well as the type of communication data (e.g., telephone call, email, text message) received.

The collected data can be stored locally on the mobile communication device in a data package. In some implementations, the mobile communication device can upload the data package to a location mapping database located on a server associated with a service provider. The server can securely store the data for the user in the database. In some implementations, the location mapping database can anonymously and securely store data packages from a plurality of users for use with a data mining application in order to predict user behavior based on a determined semantic location. Each of the users can provide explicit approval for the collection of such data, and can opt into or opt out of such data collection.

In some implementations, the server can run the data mining application on the data packages from the plurality of users. In some implementations, the server can run the data mining application on the data packages for a single user. In some implementations, the user may opt not to have their data packages stored in the location mapping database. In this case, the mobile communication device can include storage for the data packages. The mobile communication device can download and run the data mining application locally on the mobile communication device.

For example, the data mining application can run data mining algorithms on a plurality of stored data packages for a user to determine from the location data one or more clusters or groups of locations that a user frequents (e.g., work office, meeting room, school, theater, grocery store, etc.). In addition, the data mining algorithms can predict the expected user response to incoming communication data received at a location included in a particular group based on previous responses of the user to incoming communication data at that location. For example, an inference system can create clusters of locations where each location cluster can have an associated location label (e.g., home, work, school, theater, meeting room, store, etc.). The inference system can combine two locations that are spatially close and have similar behavior into the same location. For example, the location label “home” may include the physical dwelling and, in addition, the yard and other surrounding structures (e.g., a detached garage, a boathouse).

Each location can include a profile that further defines additional locations (sub-locations) included within the main location. For example, “work” can include sub-locations “cafeteria,” “office,” “conference room,” and “lab.” In some implementations, an expected user response to incoming communication data can be based on the sub-location associated with their location. For example, a user may not acknowledge any incoming communication data while attending a meeting in a conference room yet may acknowledge all incoming communication data while eating lunch in a cafeteria.

An expected user response to incoming communication data at a certain location is associated with the location label for the determined location. Therefore, when receiving incoming data, the mobile communication device can determine an expected user response based on the location label associated with the current determined location of the mobile communication device. In some implementations, the expected user response can be further based on a sub-location where the location data determines the mobile communication device is further located in an area within the location (e.g., a conference room at work).

For example, a data collection application running on a mobile communication device collects data regarding the user's response to incoming phone calls and the user's geographic location when the mobile phone receives the calls. In addition, the data collection application determines the identity of the caller and the time of day of receipt of the incoming call. A data mining algorithm run on data packages of collected data from the mobile phone associates the user response “does not answer phone calls” with the location label “theater.” For each location a probabilistic model can be created that predicts, as a function of location, an expected user response (predicted user behavior) based on previous responses generated by the user in the same location in the past. The probabilistic model can include one or more rules associated with an expected user response. For example, a rule associated with the predicted behavior “does not answer phone calls” for the location label “theater” can automatically forward the incoming call to the user's voicemail. The user can optionally allow a prediction system to use the probabilistic models and rules to automatically take action when the mobile communication device receives incoming communication data. Therefore, for example, when the user subsequently receives a phone call while located in a theater, the mobile phone will know that the user will not answer the call and can automatically forward the incoming call to the user's voicemail. For example, another rule can be to silence automatically the mobile phone when it is determined that the user is located in a location associated with the location label “theater.”

A rule can be an automatic action taken by the mobile communication device when it is determined that the user is located in a location when receiving incoming communication data. In some implementations, the user may further customize the automatic action. For example, the user may create a voicemail greeting (response) for each of the identified location labels. The voicemail greeting used when the incoming call is automatically and directly forwarded to voicemail while the user is located in a theater can indicate the location of the user as well as when the user may be able to either return the phone call or receive another phone call.

In some implementations, the expected response to incoming communication data can be based on a default response not directly associated with the user. In this case, a data mining application running on a server of a service provider can run data mining algorithms on data packages collected from multiple users to determine a common user response to incoming communication data for a particular location label. For example, the data mining algorithms can determine a response based on the most common user response and set this as the default response for incoming communication data received at the associated location label.

In some implementations, a user interface presented on a display device on the user's mobile communication device can allow the user the option to select the default rule for responding to incoming communication data received at the associated location label or to select an alternative rule for responding. For example, the response for a user receiving an incoming phone call on their mobile phone while in a theater is not to answer the call. A default rule for this response can be to automatically forward incoming calls received while in a theater to voicemail. An alternative rule may be to silence the mobile phone, but allow the mobile phone to vibrate when the mobile phone receives incoming phone calls while the user is in a theater.

In some implementations, user response predictions can be determined based on data in the data packages that may include, in addition to the location of the user and their response to the incoming communication data, the type of data (e.g., telephone call, email, text message), the identity of the entity (e.g., caller, text message sender, email sender) who sent the communication data and the time of day of the receipt of the communication data. In some implementations, the mobile communication device can display on a display device one or more user response predictions to the user for selection as rules prior to the automatic handling of the incoming communication data by the mobile communication device.

In some implementations, the mobile communication device can select a default user response as a rule without the need for user intervention. In this case, the user may initiate running an application on their mobile communication device at a later time that presents a user interface that can allow the user to select or change the computed models and rules. In addition, the user interface can allow the user to enter or select a customized automatic action for use by the rule (e.g., a specific voicemail greeting when the incoming communication data is automatically forwarded to voicemail). For example, the user may deselect the default user response prediction as a rule and enter a new rule or select an alternative predicted response as a new rule.

Multiple location labels can be created based on clustering and inference using a plurality of data packages. In some implementations, a display device included on the user's mobile communication device can display the created location labels in a user interface. The user interface can present the created location labels as a list of items that the user may recognize as locations they may frequent while in possession of their mobile communication device (e.g., home, work, school, stores, stadiums, etc.). In some implementations, the display device can display the one or more locations associated with a location label using a map-based user interface. In some cases, a map can reflect the current location of the user. In other cases, the map can be of a location specified by the user that can be different from their current location.

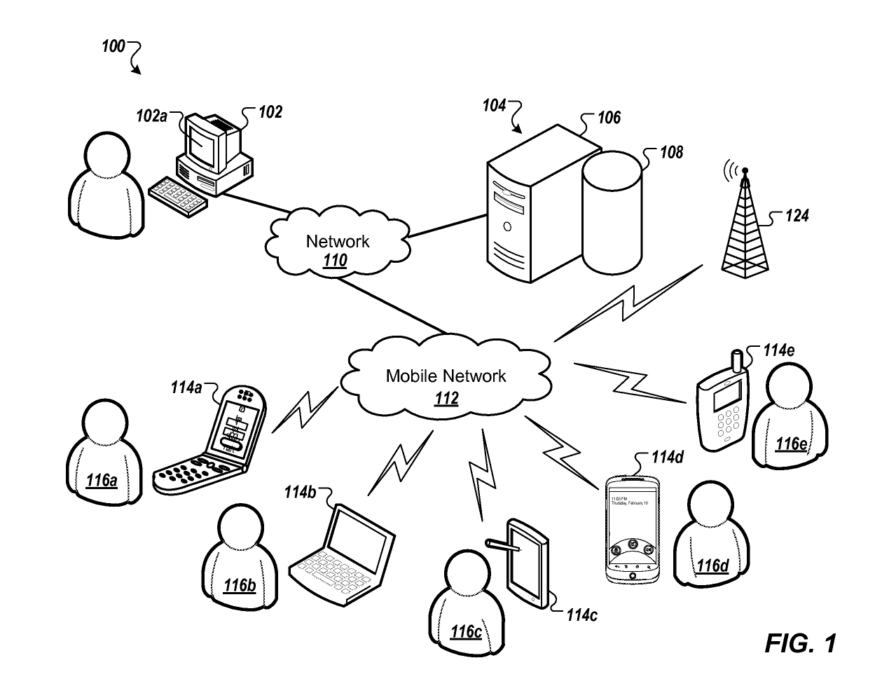

FIG. 1 illustrates an example system 100 that can execute implementations of the present disclosure. The system 100 can include a client 102 and computer system 104. The computer system 104 can include server 106 and location mapping database 108 that are connectively coupled for communication with one another over a network 110. In some implementations, the client (e.g., client 102) may be directly connected to the server (e.g., server 106) (without connecting by way of network 110).

The client 102 can represent various forms of processing devices including, but not limited to, a desktop computer, a laptop computer, a handheld computer, a personal digital assistant (PDA), a cellular telephone, a network appliance, a camera, a smartphone, an enhanced general packet radio service (EGPRS) mobile phone, a media player, a navigation device, an email device, a game console, or a combination of any two or more of these data processing devices or other data processing devices. The client 102 may access application software on the server 106.

The server 106 can represent various forms of servers including, but not limited to a web server, an application server, a proxy server, a network server, or a server farm. For example, the server 106 can be an application server that executes software accessed by the client 102. In another example, the server can be an application server that executes data mining algorithms using data packages for a plurality of users stored in the location mapping database 108.

In operation, the client 102 can communicate with the server 106 by way of network 110. In some implementations, a user can invoke applications available on the server 106 in a web browser running on the client 102. Each application can individually access data from the location mapping database 108. In some implementations, the user can use client 102 to manage the location based tagging of incoming communication data for one or more mobile devices also owned by the user. The client 102 can run an application that can display a user interface on display device 102a to allow the user to select and/or change computed models and rules for a location. The models can be stored in the location mapping database 108 for the user. In some implementations, the location mapping database 108 can store one or more models where each mobile communication device belonging to the user can have its own models.

In some implementations, all of the mobile communication devices belonging to the user can use a set of one or more models. In addition, the user interface can allow the user to enter or select a customized automatic action for use by a rule (e.g., a specific voicemail greeting when the incoming communication data is automatically forwarded to voicemail). For example, the user may deselect the default user response prediction as a rule and enter a new rule or select an alternative predicted response as a new rule. The result of the selection and/or changes can be stored in a secure location in the location mapping database 108 for the user. The server 106 can subsequently download the computed models to the one or more mobile communication devices belonging to the user. In some cases, the user may have separate models and rules for each of their mobile communication devices (e.g., one set of models and rules for their mobile phone and another set of models and rules for their laptop computer). In some cases, the same set of models and rules may be used for all of the user's mobile communication devices.

The system 100 also includes mobile network 112. Multiple mobile communication devices 114a-e (e.g., mobile phone 114a, laptop computer 114b, tablet computer 114c, smartphone 114d and personal digital assistant (PDA) 114e) may communicate wirelessly through a communication interface (not shown), which may include digital signal processing circuitry where necessary. The communication interface may provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver 124. In addition, short-range communication may occur, such as using a Bluetooth, WiFi, or other such transceiver.

In some implementations, the system 100 can be a distributed client/server system that spans one or more networks such as network 110 and mobile network 112. Each network can be a large computer network, such as a local area network (LAN), wide area network (WAN), the Internet, a cellular network, or a combination thereof connecting any number of mobile clients, fixed clients, and servers. In some implementations, the client 102 can communicate with the server 106 via a virtual private network (VPN), Secure Shell (SSH) tunnel, or other secure network connection. In some implementations, the networks can include the Internet, a wireless service network and may include the Public Switched Telephone Network (PSTN). In other implementations, the network 110 may include a corporate network (e.g., an intranet) and one or more wireless access points.

For example, users 116a-e may own and operate mobile communication devices 114a-e, respectively. Each mobile communication device 114a-e can run an application that collects data regarding the user's behavior when receiving incoming communication data. In some implementations, data packages that include the collected data can be uploaded to the server 106 by way of mobile network 112 for secure storage on location mapping database 108. Server 106 can run data mining algorithms on the collectively stored data packages for the multiple users 116a-e. As described, the data mining algorithms and an inference system can create probabilistic models and rules. Each mobile communication device 114a-e can download the probabilistic models and rules from the server 106 for local storage and retrieval. The users 116a-e can optionally run a prediction system on mobile communication devices 114a-e, respectively, that will enable the probabilistic models and rules to automatically take action when the mobile communication device receives incoming communication data.

In some implementations, each mobile communication device 114a-e can run an application that collects data regarding the user's behavior when receiving incoming communication data. Data packages that include the user's collected data can remain on the user's device. For example, mobile phone 114a runs an application on the mobile phone 114a that collects data regarding the behavior of user 116a to create locally stored data packages. The mobile phone 114a can download a data mining application from the server 106 to run on the mobile phone 114a. The data mining application can use data mining algorithms and an inference system to create probabilistic models and rules that are stored and used locally on the mobile phone 114a. The user 116a can optionally run a prediction system on the mobile phone 114a that will enable the probabilistic models and rules to automatically take action when the mobile phone 114a receives incoming communication data.

The use of data packages from a plurality of users to determine the probabilistic models and rules can take advantage of improved predicted behavior with the use of a large amount of aggregate data. In this case, the probabilistic models and rules may not be customized per user, and may provide a more general overall behavior prediction for a large number of users. In some implementations, the probabilistic models and rules can be modified (customized) for a single user. Though the aggregate amount of data for a single user may be small in comparison to the total aggregate amount of data, the user behavior can be used to modify the probabilistic models and rules. For example, the data mining application can use data mining algorithms and an inference system to create probabilistic models and rules using the data packages for a single user. The results can be used to modify the probabilistic models and rules by, for example, adding an additional rule to a model.

In some implementations, each mobile communication device 114a-e can manage the location based tagging of incoming communication data locally for the device. For example, the mobile communication device (e.g., PDA 114e) can run an application that can display a user interface on PDA display 126 to allow the user to select and/or change computed models and rules for a location label. In addition, the user interface can allow the user to enter or select a customized automatic action for use by the rule (e.g., a specific voicemail greeting when the incoming communication data is automatically forwarded to voicemail). For example, the user may deselect the default user response prediction as a rule and enter a new rule or select an alternative predicted response as a new rule. The result of the selection and/or changes can be stored locally on the PDA 114e for use by the user 116e on PDA 114e.

Referring to FIG. 1, there are a variety of mobile communication devices (e.g., mobile communication devices 114a-e) that one or more users 116a-e can use for mobile communications. The mobile communication devices 114a-e can be used by users 116a-e in a variety of locations. In addition, incoming and outgoing communication data can be in multiple formats. In some cases, a mobile communication device may have the ability to send and receive communication data in multiple formats. For example, user 116a of mobile phone 114a may send and receive phone calls and SMS text messages. The user 116a may not be able to send and receive email messages on the mobile phone 114a. In another example, user 116b of laptop computer 114b may send and receive email, multimedia files and alerts on the laptop computer 114b. The user 116d of smartphone 114d may send and receive phone calls, SMS text messages, email, multimedia files and alerts on the smartphone 114d.

In some implementations, the users 116a-e can be different users of mobile communication devices 114a-e, respectively. In some implementations, for example, user 116b, user 116c and user 116d may be the same user (a single user). A single user may own multiple mobile communication devices. In some implementations, each mobile communication device (e.g., laptop computer 114b, tablet computer 114c and smartphone 114d) owned by the single user may manage location based tagging of incoming communication data for each mobile communication device separately. Each mobile communication device may individually run an application that collects data regarding the single user's behavior when receiving incoming communication data on the specific mobile communication device where the data packages that include the single user's collected data remain on the specific mobile communication device.

For example, tablet computer 114c runs an application on the tablet computer 114c that collects data regarding the behavior of user 116c (who is the same user as user 116b and user 116d) to create locally stored data packages. The tablet computer 114c can download a data mining application from the server 106 to run on the tablet computer 114c. The data mining application can use data mining algorithms and an inference system to create probabilistic models and rules that are stored and used locally on the tablet computer 114c. The single user can optionally run a prediction system on the tablet computer 114c that will enable the probabilistic models and rules to automatically take action when the tablet computer 114c receives incoming communication data. Subsequently, the single user can run the data mining application on laptop computer 114b where the resultant created probabilistic models and rules are stored and used locally on the laptop computer 114b. Additionally, the single user can run the data mining application on smartphone 114d where the resultant created probabilistic models and rules are stored and used locally on the smartphone 114d. The single user can also manage the probabilistic models and rules individually on each mobile communication device. This can allow the user the ability to customize the automatic action taken when a mobile communication device receives incoming communication data for each individual mobile communication device (e.g., laptop computer 114b, tablet computer 114c and smartphone 114d).

In some implementations, data packages from multiple mobile communication devices owned by a single user can be uploaded to server 106 and securely stored for the single user in location mapping database. Server 106 can run data mining algorithms on the single user's collectively stored data packages. As described, the data mining algorithms and an inference system can create probabilistic models and rules. Each of the single user's mobile communication devices (e.g., laptop computer 114b, tablet computer 114c and smartphone 114) can download the probabilistic models and rules from the server 106 for local storage and retrieval on each of the mobile communication devices. The single user can optionally run a prediction system on each of the mobile communication devices (e.g., laptop computer 114b, tablet computer 114c and smartphone 114) that will enable the probabilistic models and rules to automatically take action when the mobile communication device receives incoming communication data. In this case, the data mining algorithms and an inference system can create probabilistic models and rules based on a larger aggregate amount of data. The data packages are for the single user and can provide more user specific probabilistic models and rules than those provided using data packages from multiple different users. In addition, the user can run an application that can display a user interface on the display of each of the mobile communication devices (e.g., display 128 of laptop computer 114b, display 130 of tablet computer 114c, display 132 of smartphone 114d) to allow the user to select and/or change the computed models and rules stored locally on each mobile communication device (e.g., laptop computer 114b, tablet computer 114c and smartphone 114). This can allow the user to customize the models and rules for predicted behavior when receiving incoming communication data for each individual mobile computing device.

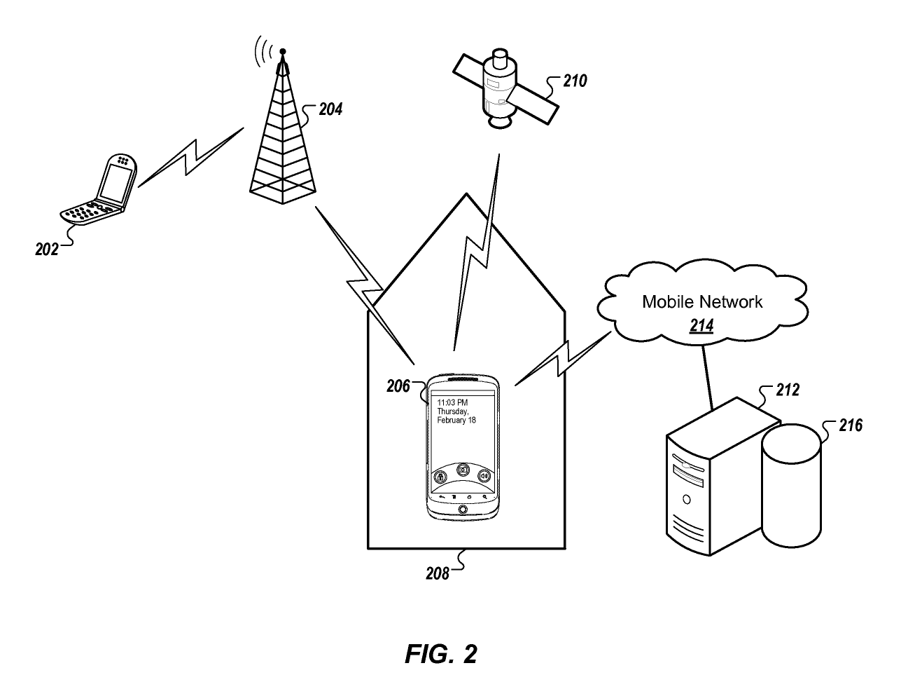

FIG. 2 illustrates an example of location based tagging of incoming communication data. In the example of FIG. 2, radio-frequency transceiver 204 receives incoming communication data from a mobile phone 202 and sends the data to smartphone 206. The smartphone 206 is located in a building 208. The smartphone 206 includes a location sensor (e.g., a GPS receiver). A GPS component in the smartphone 206, using a signal from a satellite 210, can determine the geographic location of the smartphone 206. The smartphone 206 can transmit the determined geographic location of the smartphone 206 to a server 212 by way of mobile network 214. The server 212, using the geographic location of the smartphone 206, can identify an actual location of the smartphone 206. For example, the geographic location of the smartphone 206 can be expressed in GPS coordinates. The server 212 can use the GPS coordinates to determine what is located at the coordinates (e.g., building 208).

In some cases, the smartphone 206 can be running a data collection application that collects data regarding the user's behavior when receiving the incoming communication data from the mobile phone 202. The collected data can include the actual location of the smartphone (e.g., building 208), the sender of the incoming communication data (e.g., the caller that placed the call from the mobile phone 202 to the smartphone 206), and the time of day the call is received. In addition, the data can include the user's response to the incoming communication data. The collected data can be saved locally on the smartphone 206 in a data package. The smartphone 206 may store one or more data packages. In some implementations, the smartphone 206 can upload the locally stored data packages to the server 212 for storage in the location mapping database 216. For example, the smartphone 206 can upload the locally stored data packages at a predetermined time on a daily basis. In another example, the smartphone 206 can upload each data package to the server when the data is collected. In another example, the smartphone 206 may upload the data packages once a predetermined number are stored locally on the smartphone 206. Once the smartphone 206 uploads the data packages to the server 212, the smartphone 206 can reuse the local storage space to store subsequent data packages.

As previously described, the server 212 can run a data mining application using data mining algorithms and an inference system to create probabilistic models and rules based on the user's data packages or based on data packages from the user along with other users. In some implementations, the smartphone 206 can download the resultant probabilistic models and rules for use in a prediction system running on the smartphone 206. In some implementations, the smartphone 206 can access the probabilistic models and rules by way of mobile network 214 for use in a prediction system running on the smartphone 206.

In some implementations, the data packages can remain on the smartphone 206. The smartphone 206 can download a data mining application that can run locally on the smartphone 206. The data mining application can process the locally stored data packages for the user as input for determining the probabilistic models and rules for use in a prediction system running on the smartphone 206.

In some implementations, the smartphone 206 may run both the prediction system and the data collection application. The user may initially download default probabilistic models and rules provided by the server 212. The data collection application can collect data for by the data mining application in order to update the probabilistic models and rules for the user of the smartphone 206. This can then enable updating of the automatic responses used by the prediction system based on changing user responses to incoming communication data.

In some implementations, the smartphone 206 may run either the prediction system or the data collection application. For example, when first implementing the prediction system on the smartphone 206, the user may want to collect data for a period of time (e.g., one week) for use in creating the probabilistic models and rules prior to using them in a prediction system. In another example, once the user establishes and customizes the probabilistic models and rules, the user may no longer want to collect data for use in to update the probabilistic models and rules. Therefore, the user can disable the data collection application while running the prediction system.

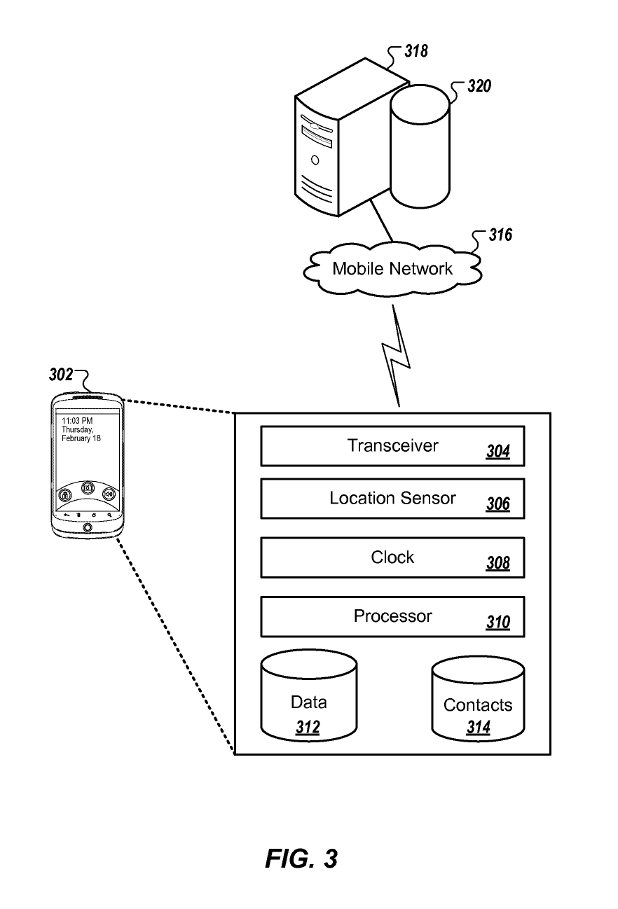

FIG. 3 is a block diagram of a mobile communication device 302 used for location based tagging of incoming communications data. An example of the mobile communication device 302 can be the smartphone 206 shown in FIG. 2. The mobile communication device 302 includes a transceiver 304, a location sensor 306, a clock 308, and processor 310. Local data storage includes data repository 312 and contacts repository 314.

The mobile communication device 302 uses the transceiver 304 to transmit and receive mobile communications data. For example, the mobile communication device 302 receives incoming communication data using transceiver 304. The mobile communication device 302 uses location sensor 306 to determine the geographic location of the mobile communication device 302. The clock 308 can provide the time of day. The processor 310 can control the operations of the mobile communication device 302.

For example, the mobile communication device 302 receives incoming communication data using the transceiver 304. When received, a data collection application running on the mobile communication device 302 can use the location sensor 306 to determine the geographic location of the mobile communication device 302 when receiving the incoming communication data. The clock 308 can provide the time of day that the mobile communication device 302 received the incoming communication data. The processor 310 can execute an application that can determine the identity of the caller based on contact information stored in the contacts repository 314. The data collection application can create a data package that includes the collected data. The application can store the data package in the data repository 312. As described with reference to FIGS. 1 and 2, the mobile communication device 302 can store one or more data packages in the data repository.

The mobile communication device 302 can transmit the one or more data packages to the server 318 by way of mobile network 316 for storage in the location mapping database 320. A data mining application running on the server 318 can use the data packages for the user along with additional data packages for other users to create probabilistic models and rules for use by the user on the mobile communication device 302. The mobile communication device can receive the probabilistic models and rules using the transceiver 304. The mobile communication device 302 can store the probabilistic models and rules in data repository 312 for use by a prediction system running on the mobile communication device 302.

In some implementations, the mobile communication device 302 can run a data mining application on the mobile communication device 302 using data packages stored in the data repository 312. The mobile communication device 302 can store the resultant probabilistic models and rules in the data repository 312 for use by a prediction system running on the mobile communication device 302. In this case, the mobile communication device 302 manages the user data locally on the user's device without uploading any user data to the server 318.

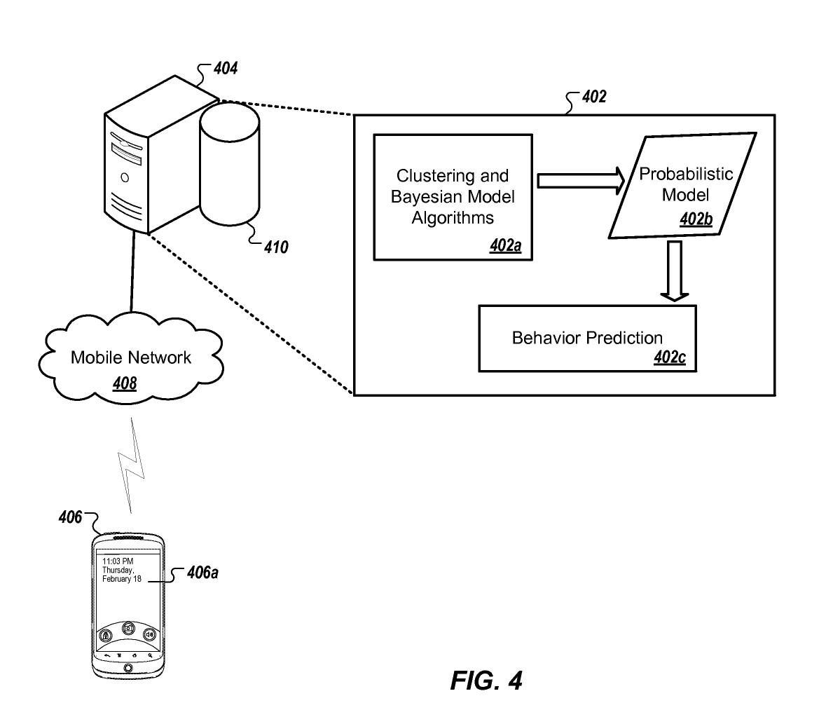

FIG. 4 illustrates server side logic 402 used by a server 404 for location based tagging of communication data. For example, a mobile communication device 406 can run a data collection application. In some implementations, the data collection application can run on a server (e.g., server 404) located on a mobile network 408. In this case, for example, the location of the mobile communication device 406 can be determined by triangulating cell tower signals. In some implementations, the data collection application can use a GPS built into the mobile communication device 406 to determine the geographic location of the mobile communication device 406. In some implementations, the data collection software can use a location application program interface to determine the location of the mobile communication device 406 based on WiFi signals or cell-ids.

When the mobile communication device 406 receives incoming communication data, the data collection software records the identity of the sender of the communication data, the type of communication data, the time of day, the location of the mobile communication device 406 and the reaction of the user to the incoming communication data. The collection of data is stored in a data package on the mobile communication device 406 and uploaded to the server 404 by way of mobile network 408 for storage on location mapping database 410. In some implementations, the mobile communication device 406 can upload batches of data packages to the server 404 on a daily basis. In some implementations, the mobile communication device 406 can upload each data package when created using local storage on the mobile communication device 406 as a buffer prior to uploading.

Once sufficient data packages are collected and stored on the location mapping database 410, the server 404 can run clustering and Bayesian model algorithms 402a on the data in the data packages to create a probabilistic model for a user. As described with reference to FIGS. 1 and 2, the data packages used for the cluster analysis can be data packages for a single user or data packages for a plurality of users. For example, support vector machines (SVMs) can analyze the data in the data packages and recognize patterns in order to classify the data. Bayesian model algorithms can use the data in the data packages to determine a prior probability. The clustering and Bayesian model algorithms 402a can output a probabilistic model 402b for a user. In some implementations, the server 404 can keep the probabilistic model 402b up-to-date by periodically running the clustering and Bayesian model algorithms 402a on data in data packages stored in the location mapping database 410.

Once the server 404 generates an updated or new probabilistic model, the user can be contacted for feedback on or fine-tuning of the probabilistic model. For example, the mobile communication device 406 can present to the user a user interface on a display 406a that can allow the user to visualize location labels and suggest or accept recommended actions in response to receiving incoming communication data at a given location label. For example, a user can visualize the location label “theater” and accept the recommended action in response to the incoming communication data (e.g., send incoming phone call directly to voicemail) when located at the location.

In some cases, the user can create custom responses to the receipt of the incoming mobile communication data. For example, the user can decide to not accept the default recommended action in response to the incoming data (e.g, send the incoming phone call directly to voicemail) and can create a custom response (e.g., have the mobile phone vibrate) to the receipt of incoming communication data. In some cases, the response can be based on a specific caller (or group of callers). For example, the user can visualize a location label “office”. The recommended action in response to incoming communication data from family members (a defined group of callers) can be to send an incoming call directly to voicemail. In another example, the user can visualize a sub-location label “conference room” in the location label “office” and the recommended action in response to an incoming phone call from the company CEO is to allow the phone to ring on its loudest setting.

Once the user reviews and validates the probabilistic model and rules, incoming communication data can trigger the behavior prediction system 402c when the incoming communication data matches the rules generated by the probability model. For example, given the location of a mobile phone and the identity of the caller, if the rule suggests “forward to voicemail” and the user has accepted the response, the incoming phone call will be forwarded directly to voicemail.

In some implementations, the mobile communication device 406 can download the behavior prediction system 402c and the probabilistic model 402b. The user can run the behavior prediction system locally on the mobile communication device 406 using the probabilistic model 402b.

In some implementations, recommended actions in response to incoming communication data can be the sending of a specific email response in reply to incoming emails. For example, the prediction system can send an “out of office” email response to incoming email messages received in a user's work based email account while the user is at home in the evening. In some implementations, while in the office, the prediction system can send a predefined SMS text message in response to incoming text messages received from friends and family members (two predefined groups of contacts).

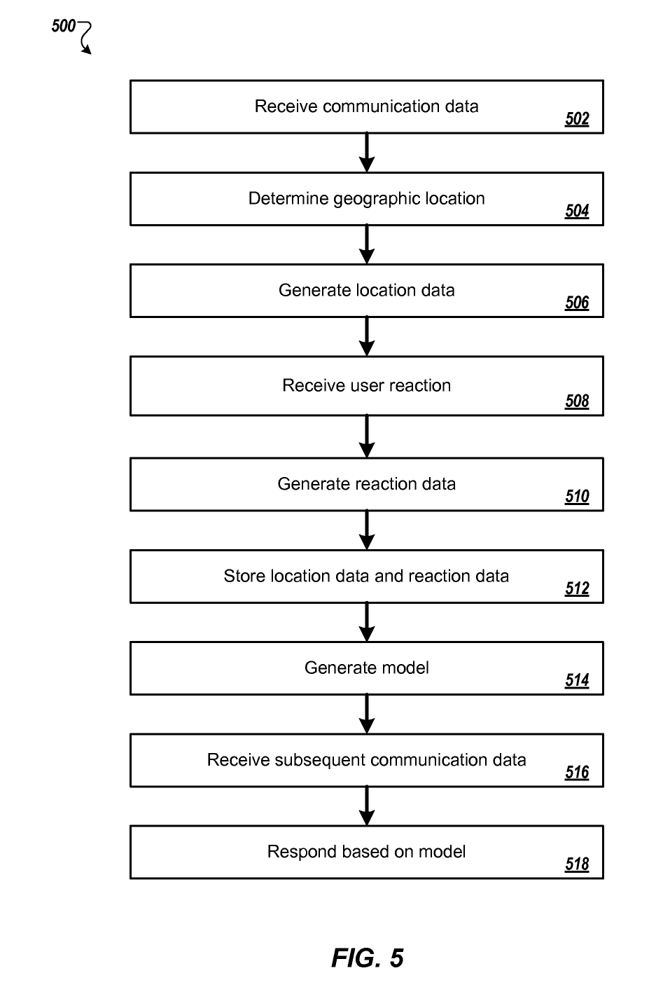

FIG. 5 is a flowchart of an example process 500 for location based tagging of incoming communication data. The process 500 can be described with reference to FIG. 2. The process 500 starts by receiving communication data (502). For example, the smartphone 206 receives an incoming phone call from mobile phone 202. The geographic location of the mobile communications device is determined (504). For example, the GPS built into the smartphone 206 can determine the geographic location of the mobile communication device 406. Location data is generated (506). For example, the determined geographic location can be used to generate location data (e.g., building 208) for the smartphone 206. The user reaction to the communication data is received (508). For example, the user of the smartphone 206 does not answer the incoming phone call from mobile phone 202. Reaction data is generated (510). For example, data indicating the user of the smartphone 206 did not answer the incoming phone call is generated. The location data and the reaction data is stored (512). For example, a data package that includes the location data and the reaction data is stored on the smartphone 206. A model is generated based on the data package (514). For example, a data mining algorithm can use the data package and other additional data packages to generate a probabilistic model. Subsequent communication data is received (516). For example, an incoming phone call is sent from mobile phone 202 and received by the smartphone 206. The subsequent communication data is responded to based on the model (518). For example, the prediction system responds to the incoming phone call from mobile phone 202 while the smartphone 206 is located in building 208.

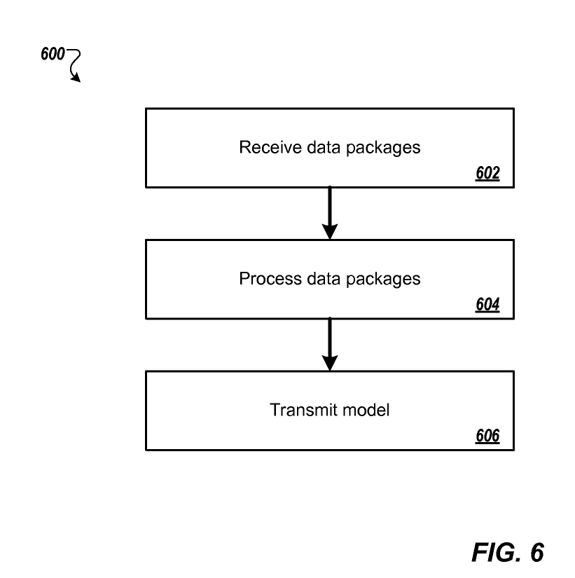

FIG. 6 is a flowchart of an example process 600 for generating a probabilistic model for use in location based tagging of incoming communication data. The process 600 can be described with reference to FIG. 4. The process 600 starts by receiving one or more data packages (602). For example, the server 404 receives data packages from one or more mobile communication devices (e.g., server 106 and mobile communication device 114a-e). The server 404 stores the data packages on location mapping database 410. Each data package can include location data and associated reaction data to incoming communication data received at mobile communication device 406. The data packages are processed (604). For example, the server 404 runs a data mining application that processes the data packages and generates a probabilistic model that includes one or more rules for reacting to received communication data. The model is transmitted (606). For example, the model is transmitted from the server 404 to the mobile communication device 406. In some implementations, for example referring to FIG. 1, the server 106 can transmit the model by way of mobile network 112 to mobile communication devices 114a-e.

The systems discussed here may provide one or more mechanisms for collecting personal information about users of the systems. Users may be provided with an opportunity to opt in/out of programs or features that may collect personal information (e.g., information about a user's preferences or a user's current location), and may be informed of the accompanying limitations on the functionality of a service that may result from such a decision. In addition, certain data may be anonymized in one or more ways before it is stored or used, so that personally identifiable information is removed. For example, a user's identity may be anonymized so that the personally identifiable information cannot be determined for the user, or a user's geographic location may be generalized where location information is obtained (such as to a city, zip code, or state level), so that a particular location of a user cannot be determined.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

The various embodiments and all of the functional operations described in this specification can be implemented in digital electronic circuitry, or in computer software, firmware, or hardware, including the structures disclosed in this specification and their structural equivalents, or in combinations of one or more of them. The embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the embodiments can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The embodiments described can be implemented in a computing system that includes a back end component, e.g., as a data server, or that includes a middleware component, e.g., an application server, or that includes a front end component, e.g., a client computer having a graphical user interface or a Web browser through which a user can interact with an implementation described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the described embodiments or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Thus, particular embodiments have been described. Other embodiments are within the scope of the following claims. For example, the actions recited in the claims can be performed in a different order and still achieve desirable results.

What is claimed is:

1. A method, comprising:
receiving, at a computing device, communication data;
defining, in response to receipt of the communication data, location data, the location data being based at least in part on a current geographic location of the computing device;
receiving user input at the computing device, the user input being indicative of a reaction of a user to receipt of the communication data;
defining one or more rules for reacting to received communication data, the one or more rules being defined based at least in part on the user input and the location data;
receiving, at the computing device, subsequent communication data; and
performing, in response to receipt of the subsequent communication data, an action, the action being performed at the computing device and being selected based at least in part on the one or more rules.

2. The method of claim 1, further comprising transmitting the location data and the communication data to a server, the server defining the one or more rules and transmitting the one or more rules to the computing device.

3. The method of claim 1, further comprising:
displaying the one or more rules to the user in an interface on a display device included in the computing device; and
receiving user validation of the one or more rules by way of the interface, where the user validation is received prior to receiving subsequent communication data.

4. The method of claim 1, further comprising:
receiving one or more modifications from the user by way of the interface;
modifying the one or more rules based on the received user modifications to provide one or more modified rules; and
storing the one or more modified rules on the computing device.

5. The method of claim 1, wherein the computing device is a mobile communication device.

6. The method of claim 1, wherein the communication data is one of a telephone call, a Short Message Service (SMS) message, an electronic mail (email) message, an instant message or an alert.

7. The method of claim 1, wherein the current geographic location of the computing device is determined based on one of a Global Positioning System (GPS) or a location application program interface on the computing device.

8. The method of claim 1, wherein the one or more rules for reacting to received communication data are defined further based on an identity of the sender of the communication data, and a time of day associated with the receipt of the communication data.

9. The method of claim 1, further comprising receiving user input for use as a reaction for the one or more rules.

10. The method of claim 9, wherein the user input is one of a recorded voicemail response or automatic email response.

11. A method, comprising:
receiving, at a computing device, location data and reaction data corresponding to a reaction of a user of a mobile communication device to communication data received at the mobile communication device;
processing the location data and the reaction data to define one or more rules for reacting to received communication data; and
transmitting the one or more rules to one or more mobile communication devices.

12. The method of claim 11, wherein receiving the location data and the reaction data further comprises storing the location data and the reaction data in a location mapping database on a server.

13. The method of claim 11, wherein receiving the location data and the reaction data occurs at a set time of day.

14. A system comprising:
one or more processors; and
a computer-readable medium coupled to the one or more processors having instructions stored thereon which, when executed by the one or more processors, cause the one or more processors to perform operations comprising:
receiving communication data;
defining, in response to receipt of the communication data, location data, the location data being based at least in part on a current geographic location of a computing device;
receiving user input, the user input being indicative of a reaction of a user to receipt of the communication data;
defining one or more rules for reacting to received communication data, the one or more rules being defined based at least in part on the user input and the location data;
receiving subsequent communication data; and
performing, in response to receipt of the subsequent communication data, an action, the action being performed at the computing device and being selected based at least in part on the one or more rules.

15. The system of claim 14, wherein the operations further comprise transmitting the reaction data and the location data to a server, the server defining the one or more rules and transmitting the one or more rules to the computing device.

16. The system of claim 14, wherein the operations further comprise:
displaying the one or more rules to the user in an interface on a display device included in the computing device; and
receiving user validation of the one or more rules by way of the interface, where the user validation is received prior to receiving subsequent communication data.

17. The system of claim 16, wherein the operations further comprise:
receiving one or more modifications from the user by way of the interface;
modifying the one or more rules based on the received user modifications to provide one or more modified rules; and
storing the one or more modified rules on the computing device.

18. A system comprising:
one or more processors; and
a computer-readable medium coupled to the one or more processors having instructions stored thereon which, when executed by the one or more processors, cause the one or more processors to perform operations comprising:
receiving location data and reaction data associated with user input received at a mobile communication device in response to a received mobile communication;
defining one or more rules based at least in part on the location data and reaction data, the one or more rules indicating one or more operations to be executed upon receipt of communication data when the mobile communication device is physically located within a geographic region defined by the location data; and
transmitting the one or more rules to one or more mobile communication devices.

19. The system of claim 18, wherein receiving the location data and reaction data further comprises storing the location data and reaction data in a location mapping database on a server.

20. The system of claim 18, wherein receiving location data and reaction data occurs at a set time of day.
